(19) United States
(12) Patent Application Publication
(10) Pub. No.: US 2025/0208464 A1
(43) Pub. Date: Jun. 26, 2025

(54) LIQUID CRYSTAL PANEL

(71) Applicant: Sharp Display Technology Corporation, Kameyama City (JP)

(72) Inventor: Shinji SHIMADA, Kameyama City (JP)

(21) Appl. No.: 18/956,358

(22) Filed: Nov. 22, 2024

(30) Foreign Application Priority Data
Dec. 22, 2023 (JP) 2023-217381

(51) Int. Cl. G02F 1/1335; G02F 1/1339

(52) U.S. Cl. CPC G02F 1/133514; G02F 1/133512; G02F 1/13394; G02F 1/13396

(57) ABSTRACT

Provided is a liquid crystal panel with spacers tending not to peel off and with a high pixel aperture ratio. The liquid crystal panel includes a color filter substrate including a color filter layer and multiple spacers protruding toward a liquid crystal layer. The color filter layer includes at least a first-color filter and a second-color filter adjacent to the first-color filter in the row direction. The first-color filter includes a first continuous pattern portion disposed continuously to overlap a first subpixel group arranged in the column direction, and a first protrusion pattern portion protruding in the row direction from the first continuous pattern portion. The second-color filter includes a second continuous pattern portion disposed continuously to overlap a second subpixel group arranged in the column direction. The spacers each include a color filter stack including the first protrusion pattern portion and a part of the second continuous pattern portion.

### CROSS-REFERENCE TO RELATED APPLICATIONS

The present application claims priority under 35 U.S.C. § 119 to Japanese Patent Application No. 2023-217381 filed on Dec. 22, 2023, the contents of which are incorporated herein by reference in their entirety.

### BACKGROUND OF THE INVENTION

### Field of the Invention

The following disclosure relates to liquid crystal panels.

### Description of Related Art

Liquid crystal display devices have, for example, a configuration including a liquid crystal panel with an active matrix substrate using active elements typified by thin film transistors (TFTs), a color filter substrate including color filters, and a liquid crystal layer sandwiched between the active matrix substrate and the color filter substrate. Spacers are disposed between the active matrix substrate and the color filter substrate in order to maintain the thickness of the liquid crystal layer.

Examples of the spacers include photo spacers (PSs) formed by photolithography. Studies have been made to stack colored layers used for color filters to obtain photo spacers (e.g., JP 3953588 B and JP 2006-072388 A).

JP 3953588 B discloses a color filter in which many columnar bodies having a function of controlling the gap between the color filter and a counter substrate are formed on a colored layer, and the columnar bodies are formed by photolithography. JP 3953588 B discloses that, as shown in FIG. 1(B), the columnar bodies 4 are formed by stacking red (R), green (G), and blue (B) colored layers (paragraph 0010).

JP 2006-072388 A discloses a liquid crystal display element including a first substrate having a first electrode on a first insulating substrate, a second substrate having a second electrode on a second insulating substrate, a liquid crystal layer disposed between the first substrate and the second substrate facing each other, a seal area disposed between the two substrates and on a peripheral portion of a selected one of the first and second substrates exclusive of a liquid crystal injection area where a liquid crystal layer is injected, a plurality of colored layers disposed on the selected substrate, each of the colored layers positioned in an effective pixel area, and a plurality of spacers, each of the spacers including a plurality of spacer layers formed through the same process as the colored layers, wherein the plurality of spacers is positioned near the liquid crystal injection area (see FIGS. 4(a) and 4(b)).

### BRIEF SUMMARY OF THE INVENTION

Liquid crystal panels have recently been used as display panels for head mounted displays (hereinbelow, HMDs). Liquid crystal panels having a resolution as high as 1000 ppi or higher, for example, are used for the display panels for HMDs. The areas where spacers including a stack of colored layers are disposed have a low transmittance, and thus the increase in resolution of the liquid crystal panel has led to a desire for reduced spacer diameters.

Photo spacers including a stack of colored layers as disclosed in JP 3953588 B and JP 2006-072388 A have conventionally been used in large-sized panels, and mainly used ones have been photo spacers in isolated patterns. However, photo spacers including a stack of colored layers and disposed in isolated patterns easily peel off when they have a smaller diameter. However, the photo spacers, when having a larger diameter, decrease the pixel aperture ratio although they are less likely to peel off. Thus, there is room for further studies regarding spacers appliable to high-resolution liquid crystal panels.

In response to the above issues, an object of the present invention is to provide a liquid crystal panel with spacers tending not to peel off and with a high pixel aperture ratio.

(1) One embodiment of the present invention is directed to a liquid crystal panel including multiple subpixels disposed in a row direction and a column direction, the liquid crystal panel including: an active matrix substrate including pixel electrodes disposed in the respective subpixels; a color filter substrate; and a liquid crystal layer sandwiched between the active matrix substrate and the color filter substrate, the color filter substrate including a color filter layer and multiple spacers protruding toward the liquid crystal layer, the color filter layer including at least a first-color filter and a second-color filter adjacent to the first-color filter in the row direction, the first-color filter including a first continuous pattern portion disposed continuously to overlap a first subpixel group arranged in the column direction among the multiple subpixels, and a first protrusion pattern portion protruding in the row direction from the first continuous pattern portion, the second-color filter including a second continuous pattern portion disposed continuously to overlap a second subpixel group arranged in the column direction among the multiple subpixels, the multiple spacers each including a color filter stack that includes the first protrusion pattern portion and a part of the second continuous pattern portion.

(2) In an embodiment of the present invention, the liquid crystal panel includes the structure (1), the color filter layer further includes a third-color filter adjacent to an opposite side of the second-color filter from the first-color filter in the row direction, the third-color filter includes a third continuous pattern portion disposed continuously to overlap a third subpixel group arranged in the column direction among the multiple subpixels, and a third protrusion pattern portion protruding in the row direction from the third continuous pattern portion, and at least one of the spacers among the multiple spacers includes, in its color filter stack, the first protrusion pattern portion, a part of the second continuous pattern portion, and the third protrusion pattern portion.

(3) In an embodiment of the present invention, the liquid crystal panel includes the structure (2), and a maximum width of the third protrusion pattern portion in the column direction is greater than a maximum width of the first protrusion pattern portion in the column direction.

(4) In an embodiment of the present invention, the liquid crystal panel includes any one of the structures (1) to (3), and the first-color filter is one of a red color filter or a green color filter.

(5) In an embodiment of the present invention, the liquid crystal panel includes any one of the structures (2) to (4), the first-color filter is one of a red color filter or a green color filter, the second-color filter is a blue color filter, and the third-color filter is the other of the red color filter or the green color filter.

(6) In an embodiment of the present invention, the liquid crystal panel includes any one of the structures (1) to (5), and the part of the second continuous pattern portion is in a side in the color filter stack closest to the liquid crystal layer.

(7) In an embodiment of the present invention, the liquid crystal panel includes any one of the structures (1) to (6), the color filter substrate further includes a black matrix, the black matrix includes multiple apertures arranged in the respective subpixels and a light blocking portion surrounding the multiple apertures, the multiple spacers include a spacer overlapping the light blocking portion, the multiple apertures include multiple first apertures overlapping the first continuous pattern portion and multiple second apertures overlapping the second continuous pattern portion except for the part of the second continuous pattern portion, and the multiple second apertures include a second aperture having a smaller area than the first apertures.

(8) In an embodiment of the present invention, the liquid crystal panel includes any one of the structures (1) to (7), the color filter substrate includes an overcoat layer disposed in a liquid crystal layer side of the color filter layer, and a thickness of the overcoat layer is smaller than a thickness of the color filter stack.

(9) In an embodiment of the present invention, the liquid crystal panel includes any one of the structures (1), (4), and (6) to (8), the color filter stack is a stack of the first protrusion pattern portion and the part of the second continuous pattern portion, and a thickness of the color filter stack is less than twice a thickness of the first continuous pattern portion.

(10) In an embodiment of the present invention, the liquid crystal panel includes any one of the structures (2) and (3) to (8), the color filter stack is a stack of the first protrusion pattern portion, the part of the second continuous pattern portion, and the third protrusion pattern portion, and a thickness of the color filter stack is less than three times a thickness of the first continuous pattern portion.

(11) In an embodiment of the present invention, the liquid crystal panel includes any one of the structures (1) to (10), a maximum width of the first protrusion pattern portion in the column direction is equal to or more than 0.5 times and equal to or less than 1.5 times a width of the first continuous pattern portion in the row direction.

(12) In an embodiment of the present invention, the liquid crystal panel includes any one of the structures (1) to (11), the color filter layer further includes a third-color filter adjacent to an opposite side of the second-color filter from the first-color filter in the row direction, one subpixel overlapping the first-color filter, one subpixel overlapping the second-color filter, and one subpixel overlapping the third-color filter constitute one pixel, the liquid crystal panel has a pixel density of 1000 ppi or more, and the multiple spacers are disposed at a density of one or more per 1000 pixels and one or less per pixel.

(13) In an embodiment of the present invention, the liquid crystal panel includes any one of the structures (2), (3) to (8), and (10) to (12), the multiple spacers include main spacers and sub spacers having a smaller thickness than the main spacers, the color filter stack in each of the main spacers is a stack of the first protrusion pattern portion, the part of the second continuous pattern portion, and the third protrusion pattern portion, and the color filter stack in each of the sub spacers is a stack of the first protrusion pattern portion or the third protrusion pattern portion and the part of the second continuous pattern portion.

(14) In an embodiment of the present invention, the liquid crystal panel includes the structure (13), one subpixel overlapping the first-color filter, one subpixel overlapping the second-color filter, and one subpixel overlapping the third-color filter constitute one pixel, and the number of the sub spacers per 1000 pixels is equal to or more than the number of the main spacers and equal to or less than 10 times the number of the main spacers.

The present invention can provide a liquid crystal panel with spacers tending not to peel off and with a high pixel aperture ratio.

### BRIEF DESCRIPTION OF THE DRAWINGS

FIG. 1 is a schematic plan view of a liquid crystal panel of an embodiment.

FIG. 2 is a schematic cross-sectional view of the liquid crystal panel taken along line X1-X2 in FIG. 1.

FIG. 3 is a schematic plan view of the color filter substrate in FIG. 1 seen from the liquid crystal layer side.

FIG. 4 is a schematic plan view of one of first-color filters shown in FIG. 3.

FIG. 5 is a schematic plan view of one of second-color filters shown in FIG. 3.

FIG. 6 is a schematic plan view of one of third-color filters shown in FIG. 3.

FIG. 7 is a schematic cross-sectional view of the liquid crystal panel taken along line X3-X4 in FIG. 1.

FIG. 8 is a schematic cross-sectional view of the liquid crystal panel taken along line X5-X6 in FIG. 1.

FIG. 9 is an enlarged schematic plan view of a spacer PS3 and its vicinity in the liquid crystal panel in FIG. 1.

FIG. 10 is a schematic plan view illustrating a first step of a method for producing the color filter substrate in FIG. 3.

FIG. 11 is a schematic cross-sectional view taken along line X3-X4 in FIG. 10.

FIG. 12 is a schematic cross-sectional view taken along line X5-X6 in FIG. 10.

FIG. 13 is a schematic plan view illustrating a second step of the method for producing the color filter substrate in FIG. 3.

FIG. 14 is a schematic cross-sectional view taken along line X3-X4 in FIG. 13.

FIG. 15 is a schematic plan view illustrating another example of the second step of the method for producing the color filter substrate.

FIG. 16 is a schematic cross-sectional view taken along line X5-X6 in FIG. 13.

FIG. 17 is a schematic plan view illustrating a third step of the method for producing the color filter substrate in FIG. 3.

FIG. 18 is a schematic cross-sectional view taken along line X3-X4 in FIG. 17.

FIG. 19 is a schematic cross-sectional view taken along line X5-X6 in FIG. 17.

FIG. 20 is a schematic plan view of a color filter substrate of Comparative Example 1 seen from the liquid crystal layer side.

FIG. 21 is a schematic cross-sectional view taken along line X7-X8 in FIG. 20.

### DETAILED DESCRIPTION OF THE INVENTION

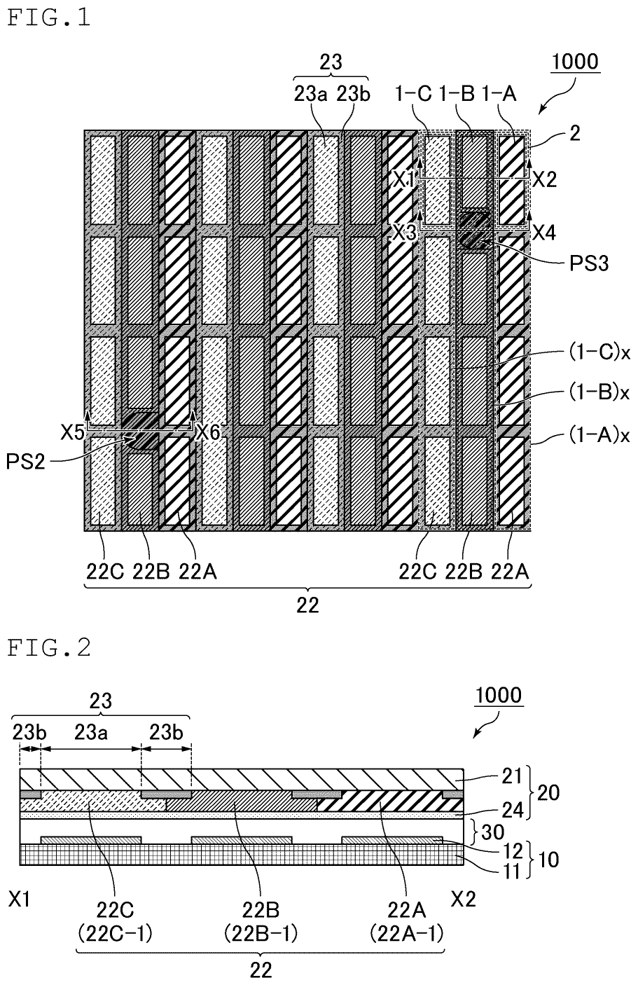

FIG. 1 is a schematic plan view of a liquid crystal panel of an embodiment. FIG. 2 is a schematic cross-sectional view of the liquid crystal panel taken along line X1-X2 in FIG. 1. FIG. 1 is specifically a schematic plan view of a liquid crystal panel 1000 observed from a color filter substrate 20 side. As shown in FIG. 1, the liquid crystal panel 1000 of the embodiment includes multiple subpixels arranged in a row direction and a column direction. The row direction is, for example, a left-right direction (0°-180° azimuth) when the right direction is at the 0° azimuth and the left direction is at the 180° azimuth during observation of the liquid crystal panel from the observer side. The column direction is a direction orthogonal to the row direction, and is, for example, a top-bottom direction (90°-270° azimuth) of the liquid crystal panel. For example, in the case of n rows and m columns, n×m subpixels are arranged in a matrix pattern.

As shown in FIG. 2, the liquid crystal panel 1000 includes an active matrix substrate 10, a color filter substrate 20, and a liquid crystal layer 30 sandwiched between the active matrix substrate 10 and the color filter substrate 20.

The active matrix substrate 10 includes pixel electrodes 12 disposed in the respective subpixels. The active matrix substrate 10 may include a supporting substrate 11. The pixel electrodes 12 may be disposed on the supporting substrate 11. The supporting substrate 11 and a supporting substrate 21, which is described later, are substrates having insulating properties (also referred to as insulating substrates), and are preferably transparent substrates. Examples thereof include glass substrates and plastic substrates.

The active matrix substrate 10 includes, although not shown, for example, multiple gate lines (scanning lines) parallel to one another, and multiple source lines (signal lines) which intersect the multiple gate lines and are parallel to one another. The multiple gate lines may not be orthogonal to the multiple source lines. The gate lines may be disposed in the row direction. The source lines may be disposed in the column direction. The multiple source lines and the multiple gate lines are formed, as a whole, in a matrix pattern (grid pattern) such that they partition the pixels. The minimum unit in the grid pattern, i.e., a region surrounded by source lines and gate lines (possibly including a region, in the color filter substrate 20 and the liquid crystal layer 30, overlapping in a plan view the region in the active matrix substrate 10 surrounded by source lines and gate lines) is referred to herein as a “subpixel”. In each subpixel, a TFT as a switching element is disposed at an intersection between a source line and a gate line. The pixel electrodes 12 are each electrically connected to, for example, the drain line of the corresponding TFT. Examples of the semiconductor layer in each TFT include amorphous silicon, polysilicon, and oxide semiconductors.

Examples of the display mode of the liquid crystal panel 1000 include transverse electric field modes such as a fringe field switching (FFS) mode and an in plane switching (IPS) mode; and vertical electric field modes such as a vertical alignment (VA) mode. The transverse electric field modes are display modes in which liquid crystal molecules in the liquid crystal layer during no voltage application are aligned parallel to a substrate surface. The vertical electric field modes are display modes in which liquid crystal molecules in the liquid crystal layer during no voltage application are aligned perpendicular to a substrate surface. The liquid crystal panel of the embodiment can easily achieve a high transmittance, and is thus preferably a transverse electric field mode liquid crystal panel, more preferably an FFS mode liquid crystal panel.

In the liquid crystal panel 1000 in a transverse electric field mode, the counter electrode is formed on the active matrix substrate 10. In the case of the FFS mode, an insulating film is disposed between the pixel electrodes and the counter electrode. In the liquid crystal panel 1000 in a vertical electric field mode, the counter electrode is formed in the color filter substrate 20 (for example, closer to the liquid crystal layer 30 than a color filter layer 22 is).

The liquid crystal layer 30 includes liquid crystal molecules, and utilizes changes in the alignment of the liquid crystal molecules according to the potential differences between the pixel electrodes and the counter electrode to control the amount of light transmitted therethrough. The liquid crystal molecules are preferably molecules of a nematic liquid crystal material that exhibits nematic liquid crystallinity within a certain temperature range. The liquid crystal molecules may have a positive or negative anisotropy of dielectric constant. The liquid crystal molecules preferably have a positive anisotropy of dielectric constant in order to increase the response speed, and preferably have a negative anisotropy of dielectric constant in order to increase the transmittance.

The color filter substrate 20 may include a supporting substrate 21, and may include the supporting substrate 21, a black matrix 23, and the color filter layer 22 stacked in the stated order.

As shown in FIG. 1, the black matrix 23 includes multiple apertures 23a in the respective subpixels, and a light blocking portion 23b surrounding the multiple apertures 23a. The black matrix 23 may be formed in a grid pattern on the supporting substrate 21. The black matrix 23 may be one usually used in the field of liquid crystal panels, such as a black photosensitive resin material or a metal material.

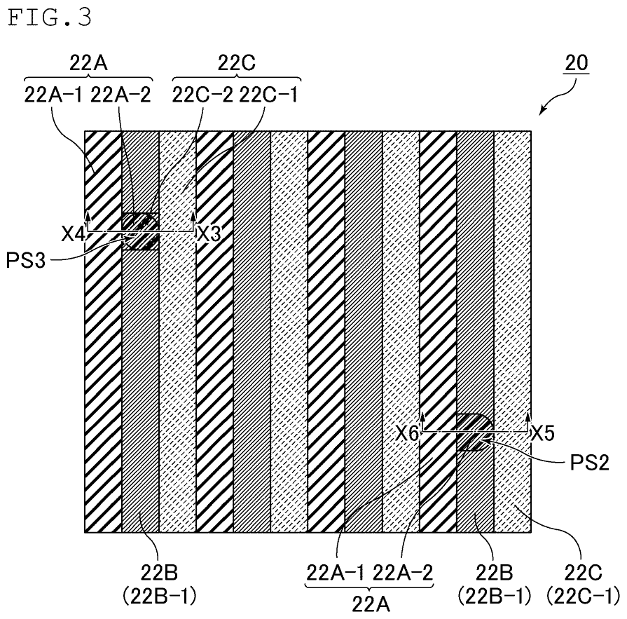

FIG. 3 is a schematic plan view of the color filter substrate in FIG. 1 seen from the liquid crystal layer side. In FIG. 3, the black matrix 23 is omitted. As shown in FIG. 3, the color filter layer 22 includes at least a first-color filter (color filter in a first color) 22A and a second-color filter (color filter in a second color) 22B adjacent to the first-color filter 22A in the row direction. The color filter layer 22 may further include a third-color filter (color filter in a third color) 22C adjacent to the opposite side of the second-color filter 22B from the first-color filter 22A in the row direction.

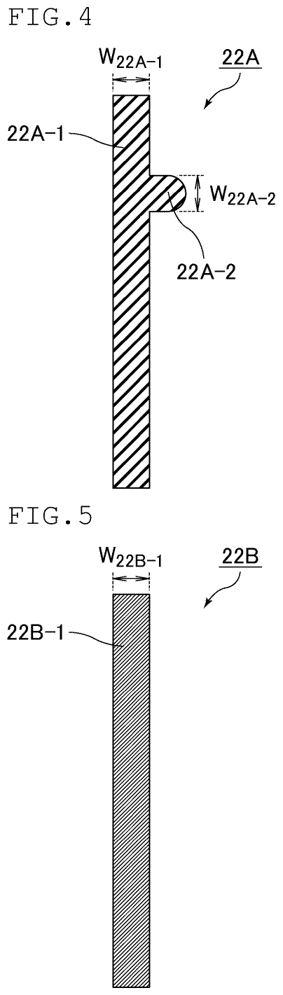

FIG. 4 is a schematic plan view of one of first-color filters shown in FIG. 3. As shown in FIG. 4, the first-color filters 22A include a first continuous pattern portion 22A-1 disposed continuously to overlap a first subpixel group (1-A)x (see FIG. 1) arranged in the column direction among the multiple subpixels, and a first protrusion pattern portion 22A-2 protruding in the row direction from the first continuous pattern portion 22A-1. At least one of the multiple first-color filters 22A includes the first continuous pattern portion 22A-1 and the first protrusion pattern portion 22A-2. The color filter layer 22 may include a first-color filter 22A consisting only of the first continuous pattern portion 22A-1.

The maximum width W₂₂₄₋₂ of the first protrusion pattern portion 22A-2 in the column direction may be equal to or more than 0.5 times and equal to or less than 1.5 times the width W_{22A-1} of the first continuous pattern portion in the row direction. To increase spacer adhesion, the W_{22A-2} is preferably equal to or more than 0.5 times the W_{22A-1}. To achieve a sufficient aperture ratio and prevent a decrease in display quality of the liquid crystal panel, the W_{22A-2} is preferably equal to or less than 1.5 time the W₂₂₄₋₁. When the liquid crystal panel is at 1000 ppi, the W_{22A-2} is more preferably 4.23 μm or more and 12.7 μm or less.

FIG. 5 is a schematic plan view of one of second-color filters shown in FIG. 3. As shown in FIG. 5, the second-color filters 22B include a second continuous pattern portion 22B-1 disposed continuously to overlap a second subpixel group (1-B)x (see FIG. 1) arranged in the column direction among the multiple subpixels. The second-color filters 22B may not include a protrusion pattern portion which protrudes in the row direction from the second continuous pattern portion 22B-1.

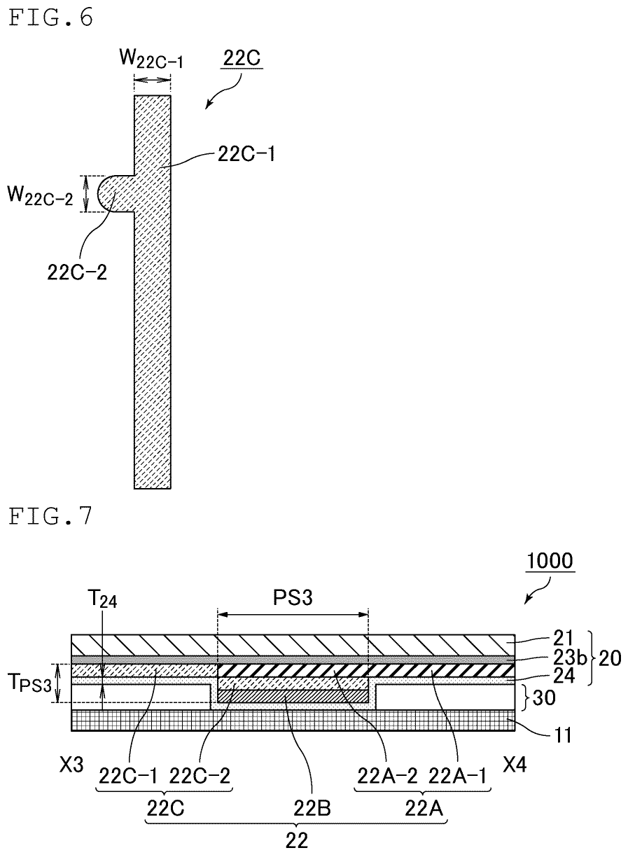

FIG. 6 is a schematic plan view of one of third-color filters shown in FIG. 3. As shown in FIG. 6, the third-color filters 22C may include a third continuous pattern portion 22C-1 disposed continuously to overlap a third subpixel group (1-C)x (see FIG. 1) arranged in the column direction among the multiple subpixels, and a third protrusion pattern portion 22C-2 protruding in the row direction from the third continuous pattern portion 22C-1. At least one of the multiple third-color filters 22C may include the third continuous pattern portion 22C-1 and the third protrusion pattern portion 22C-2. The color filter layer 22 may include a third-color filter 22C consisting only of the third continuous pattern portion 22C-1.

The first continuous pattern portion 22A-1, the second continuous pattern portion 22B-1, and the third continuous pattern portion 22C-1 are each preferably continuously disposed to overlap a corresponding subpixel group arranged in the column direction, along the source lines in the active matrix substrate 10 when the color filter substrate 20 is attached to the active matrix substrate 10.

The maximum width W₂₂₀₋₂ of the third protrusion pattern portion 22C-2 in the column direction may be equal to or more than 0.5 times and equal to or less than 1.5 times the width W₂₂₀₋₁ of the third continuous pattern portion 22C-1 in the row direction. When the liquid crystal panel is at 1000 ppi, the W₂₂₀₋₂ is more preferably 4.23 μm or more and 12.7 μm or less.

In the row direction, the width W_{22A-1} of the first continuous pattern portion 22A-1, the width of the second continuous pattern portion 22B-1, and the width W₂₂₀₋₁ of the third continuous pattern portion 22C-1 are each preferably 3 μm or more and 15 μm or less, more preferably 4 μm or more and 12 μm or less. Herein, the widths of the first, second, and third continuous pattern portions respectively mean the average width of the first continuous pattern portions, the average width of the second continuous pattern portions, and the average width of the third continuous pattern portions in the row direction excluding the protrusion pattern portions.

To sufficiently achieve a favorable color gamut, the thickness of the continuous pattern portion of a color filter of each color overlapping the corresponding aperture is preferably 0.5 μm or more and 3 μm or less, more preferably 1 μm or more and 2 μm or less. The thickness of the protrusion pattern portion of a color filter of each color may be the same as the thickness of the continuous pattern portion of the color filter of the color.

The color filter substrate 20 includes multiple spacers protruding toward the liquid crystal layer 30. The multiple spacers each include a color filter stack that includes a first protrusion pattern portion 22A-2 and a part of a second continuous pattern portion 22B-1. The spacer can be made less likely to peel off by stacking the first protrusion pattern portion 22A-2 connected to the first continuous pattern portion 22A-1 with the part of the second continuous pattern portion 22B-1 of the second-color filter 22B adjacent to the first-color filter 22A to form the spacer. Also, since the spacer is formed to overlap the second continuous pattern portion 22B-1 of the second-color filter 22B, the spacer can be compactly arranged, so that the pixel aperture ratio can be increased. The color filter stack can include, as well as the first protrusion pattern portion 22A-2 and the part of the second continuous pattern portion 22B-1, a third protrusion pattern portion 22C-2 to be described later. Herein, a spacer PS2 and a spacer PS3 to be described later are simply referred to as a spacer when no distinction is made therebetween.

FIG. 7 is a schematic cross-sectional view of the liquid crystal panel taken along line X3-X4 in FIG. 1. As shown in FIG. 7, at least one spacer among the multiple spacers preferably includes in its color filter stack a first protrusion pattern portion 22A-2, a part of a second continuous pattern portion 22B-1, and a third protrusion pattern portion 22C-2. The first protrusion pattern portion 22A-2 and the third protrusion pattern portion 22C-2 both protrude toward the second continuous pattern portion 22B-1 in a plan view. The three layers of the first protrusion pattern portion 22A-2, the part of the second continuous pattern portion 22B-1, and the third protrusion pattern portion 22C-2 are stacked to constitute the color filter stack. Herein, a spacer including a color filter stack of the three layers of color filters is referred to as a three-layer structure spacer PS3.

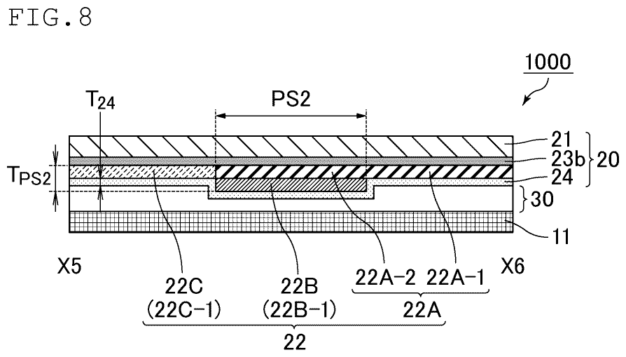

FIG. 8 is a schematic cross-sectional view of the liquid crystal panel taken along line X5-X6 in FIG. 1. As shown in FIG. 8, a spacer PS2 includes a color filter stack including a first protrusion pattern portion 22A-2 and a part of a second continuous pattern portion 22B-1. The first protrusion pattern portion 22A-2 protrudes toward the second continuous pattern portion 22B-1 in a plan view. Two layers of the first protrusion pattern portion 22A-2 and the part of the second continuous pattern portion 22B-1 are stacked to constitute the color filter stack. Herein, a spacer including a color filter stack including the two layers of color filters is also referred to as a two-layer structure spacer PS2.

As shown in FIG. 7 and FIG. 8, preferably, the part of the second continuous pattern portion 22B-1 in both the spacers PS3 and the spacers PS2 is disposed in the side in the color filter stack closest to the liquid crystal layer 30.

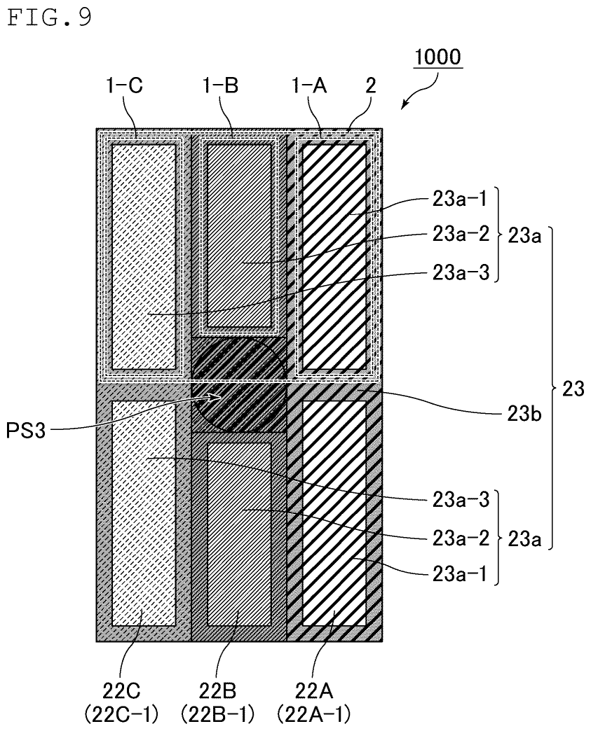

FIG. 9 is an enlarged schematic plan view of the spacer PS3 and its vicinity in the liquid crystal panel in FIG. 1. As shown in FIG. 9, the multiple spacers include a spacer overlapping the light blocking portion 23b. In the display region where the multiple subpixels are disposed, all the multiple spacers may overlap the light blocking portion 23b.

As shown in FIG. 9, the multiple apertures 23a overlap the continuous pattern portions of the color filters of the respective colors, and in each aperture 23a, the continuous pattern portion of the color filter of the corresponding color is partially exposed. The three subpixels in one pixel 2 may be equal or different in aperture area. Specifically, as shown in FIG. 1, the liquid crystal panel 1000 in a plan view may include a pixel 2 in which the three subpixels are different in aperture area and a pixel 2 in which the three subpixels are equal in aperture area. FIG. 9 shows a case where the three subpixels in one pixel 2 are different in aperture area. As shown in FIG. 9, the areas of the second apertures 23a-2 disposed in two subpixels adjacent to each other in the column direction across a spacer may be smaller than the areas of the first apertures 23a-1 and/or the third apertures 23a-3 disposed in subpixels of other color(s).

The multiple apertures 23a may include multiple first apertures 23a-1 overlapping the first continuous pattern portion 22A-1 and multiple second apertures 23a-2 overlapping the second continuous pattern portion 22B-1 except for the part of the second continuous pattern portion 22B-1 in the color filter stack. As shown in FIG. 9, the multiple second apertures 23a-2 may include a second aperture 23a-2 having a smaller area than the first apertures 23a-1. Since the part of the second continuous pattern portion 22B-1 is included in the color filter stack, the second aperture 23a-2 overlapping the second continuous pattern portion 22B-1 is disposed to avoid the position where the spacer is disposed, and thus to overlap the second continuous pattern portion 22B-1 except for the part of the second continuous pattern portion 22B-1 in the color filter stack. Thus, the area of the second aperture 23a-2 can be smaller than the area of an aperture (first aperture 23a-1) overlapping a continuous pattern portion of a different color.

Since the human eye is less sensitive to blue light, the spacers are preferably disposed on blue second continuous pattern portions. Thus, a first-color filter including a protrusion pattern portion is preferably one of a red color filter or a green color filter.

In a three-layer structure spacer, preferably, the first-color filter 22A is one of a red color filter or a green color filter, the second-color filter 22B is a blue color filter, and the third-color filter 22C is the other of the red color filter or the green color filter. Since the human eye is highly sensitive to green light, to achieve a sufficient transmittance (luminance) of the panel, the spacers are each preferably disposed to avoid a green continuous pattern portion. In forming a three-layer structure spacer, the first-color filter and the third-color filter having a protrusion pattern portion are each preferably one of a red color filter or a green color filter.

The multiple spacers may include main spacers and sub spacers having a smaller thickness than the main spacers. The color filter stack in a main spacer is a stack of a first protrusion pattern portion 22A-2, a part of a second continuous pattern portion 22B-1, and a third protrusion pattern portion 22C-2. The color filter stack in a sub spacer is a stack of a first protrusion pattern portion 22A-2 or third protrusion pattern portion 22C-2 and a part of a second continuous pattern portion 22B-1. In other words, the multiple spacers may consist only of three-layer structure spacers PS3 or two-layer structure spacers PS2, or may include both the spacers PS3 and PS2.

With the main spacers (spacers PS3) having a large thickness included, a sufficient thickness (cell thickness) of the liquid crystal layer can be achieved, so that a pressure resistance can be achieved with which the cell thickness is maintained even when external pressure is applied. In addition, thermal shrinkage of the liquid crystal layer in a low temperature environment causes air bubbles (low-temperature air bubbles), which may lead to defective display spots due to air bubbles. With the sub spacers (spacers PS2) having a smaller thickness included in addition to the main spacers, the cell thickness can be maintained with the sub spacers even when the liquid crystal layer has undergone thermal shrinkage, so that the balance can be achieved between the pressure resistance and the effect of preventing low-temperature air bubbles.

The number of the sub spacers per 1000 pixels may be equal to or more than the number of the main spacers and equal to or less than 10 times the number of the main spacers.

As shown in FIG. 9, one subpixel 1-A overlapping a first-color filter 22A, one subpixel 1-B overlapping a second-color filter 22B, and one subpixel 1-C overlapping a third-color filter 22C may constitute one pixel 2. The number of pixels per inch is also referred to as pixel per inch (ppi).

The liquid crystal panel 1000 has a pixel density of preferably 1000 ppi or higher, and the multiple spacers may be disposed at a density of one or more per 1000 pixels and one or less per pixel. The multiple spacers are more preferably disposed at a density of one or more per 100 pixels and one or less per 9 pixels. The upper limit of the pixel density is, for example, 2000 ppi. In the case where the multiple spacers include both three-layer structure spacers PS3 and two-layer structure spacers PS2, the number of the multiple spacers is the sum of the number of the spacers PS3 and the number of the spacers PS2.

The liquid crystal panel 1000 of the embodiment is suitable as a liquid crystal panel for head mounted displays because it can make the spacers less likely to peel off and can achieve a high pixel aperture ratio even when applied to a high-resolution liquid crystal panel having a pixel density of 1000 ppi or higher. The pixel density of the liquid crystal panel 1000 may be 1200 ppi or higher and may be 1400 ppi or higher.

As shown in FIG. 2, the color filter substrate 20 may include an overcoat layer 24 disposed in the liquid crystal layer 30 side of the color filter layer 22. With the overcoat layer 24, the surfaces of the continuous pattern portions (except for the part of the second continuous pattern portion 22B-1 in the color filter stack) of the respective colors can be planarized. Also, with the overcoat layer 24, the liquid crystal layer can be adjusted to be thinner than in the case where the color filter substrate 20 does not include the overcoat layer 24. The overcoat layer 24 can be formed, for example, by using a known transparent photosensitive resin, for example.

The thickness of the overcoat layer 24 is preferably smaller than the thicknesses of the color filter stacks. The thickness of the overcoat layer 24 is preferably 0.5 μm or more and 3 μm or less, more preferably 1 μm or more and 2 μm or less.

The thickness of a color filter stack means the thickness of a portion where a continuous pattern portion and a protrusion pattern portion of color filters are stacked, excluding the thicknesses of the overcoat layer and the alignment film. In the case of a three-layer structure spacer PS3, the thickness of the color filter stack means the thickness of a portion where a first protrusion pattern portion 22A-2, a part of a second continuous pattern portion 22B-1, and a third protrusion pattern portion 22C-2 are stacked. In the case of a two-layer structure spacer PS2, the thickness of the color filter stack means the thickness of a portion where a first protrusion pattern portion 22A-2 or third protrusion pattern portion 22C-2 and a part of a second continuous pattern portion 22B-1 are stacked.

A method for producing a color filter substrate is described below. In the case of the color filter substrate 20 including the black matrix 23, the black matrix 23 is preferably formed on the supporting substrate 21 in advance, which is omitted from the drawings here.

FIG. 10 is a schematic plan view illustrating a first step of a method for producing the color filter substrate in FIG. 3. As shown in FIG. 10, the first-color filters 22A including the first continuous pattern portions 22A-1 and the first protrusion pattern portions 22A-2 are patterned on the supporting substrate 21.

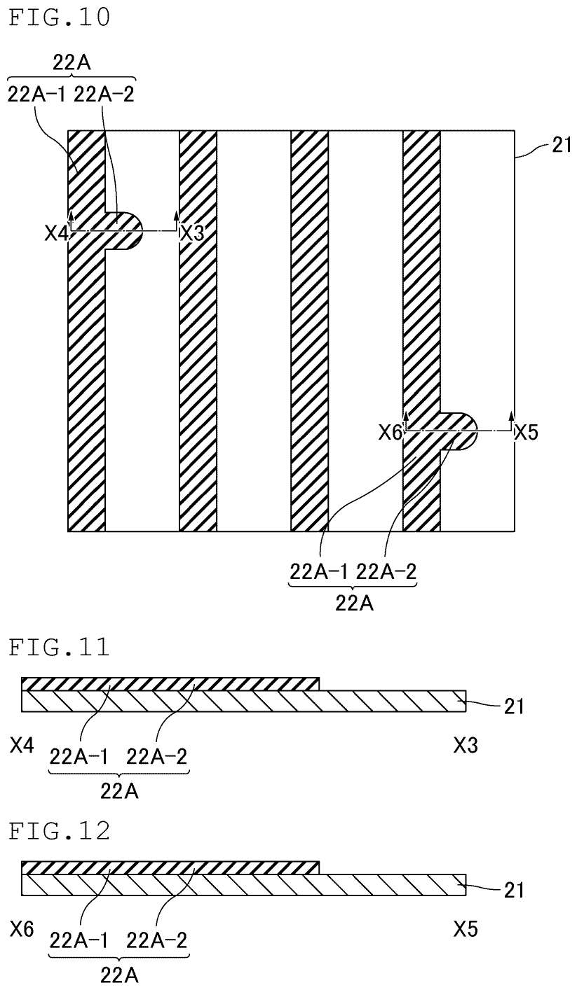

FIG. 11 is a schematic cross-sectional view taken along line X3-X4 in FIG. 10. FIG. 12 is a schematic cross-sectional view taken along line X5-X6 in FIG. 10. As shown in FIG. 11 and FIG. 12, the first continuous pattern portions 22A-1 and the corresponding first protrusion pattern portions 22A-2 are connected. Thus, formation of the first-color filters 22A on the supporting substrate can increase the adhesion of the spacers.

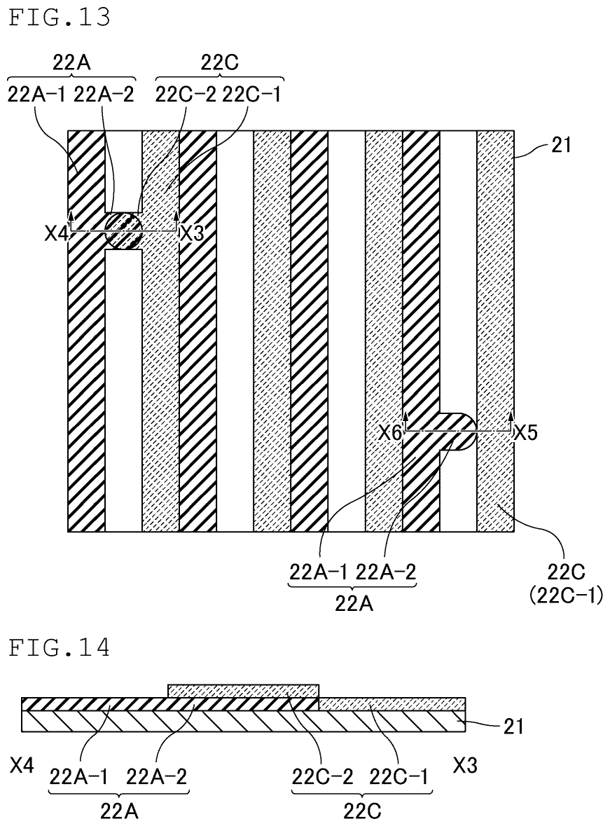

FIG. 13 is a schematic plan view illustrating the second step of the method for producing the color filter substrate in FIG. 3. FIG. 13 describes the case of forming the third-color filters 22C following the formation of the first-color filters 22A. As shown in FIG. 13, with a space corresponding to one column of a continuous pattern portion in the row direction of the first continuous pattern portions 22A-1, the third-color filters 22C are patterned on the supporting substrate 21. In the case of forming three-layer structure spacers PS3, the third-color filters 22C including the third continuous pattern portions 22C-1 and the third protrusion pattern portions 22C-2 are patterned. The third protrusion pattern portions 22C-2 are patterned to face the respective first protrusion pattern portions 22A-2 in a plan view, i.e., to protrude in the direction opposite to the protrusion direction of the first protrusion pattern portions 22A-2 in the row direction.

FIG. 14 is a schematic cross-sectional view taken along line X3-X4 in FIG. 13. As shown in FIG. 14, the third-color filters 22C are each formed such that the third protrusion pattern portion 22C-2 overlaps the corresponding first protrusion pattern portion 22A-2. The third continuous pattern portion 22C-1 and the corresponding third protrusion pattern portion 22C-2 being connected to each other can make the spacer even less likely to peel off.

The maximum width of the third protrusion pattern portion 22C-2 in the column direction may be smaller than or greater than the maximum width of the first protrusion pattern portion 22A-2 in the column direction as long as the third protrusion pattern portion 22C-2 overlaps the first protrusion pattern portion 22A-2. In FIG. 13, the case is shown where the maximum width of the third protrusion pattern portion 22C-2 in the column direction is about the same as the maximum width of the first protrusion pattern portion 22A-2 in the column direction.

FIG. 15 is a schematic plan view illustrating another example of the second step of the method for producing the color filter substrate. As shown in FIG. 15, the maximum width of the third protrusion pattern portion 22C-2 in the column direction is greater than the maximum width of the first protrusion pattern portion 22A-2 in the column direction. This mode can make the spacers even less likely to peel off. The third protrusion pattern portion 22C-2 may cover the first protrusion pattern portion 22A-2.

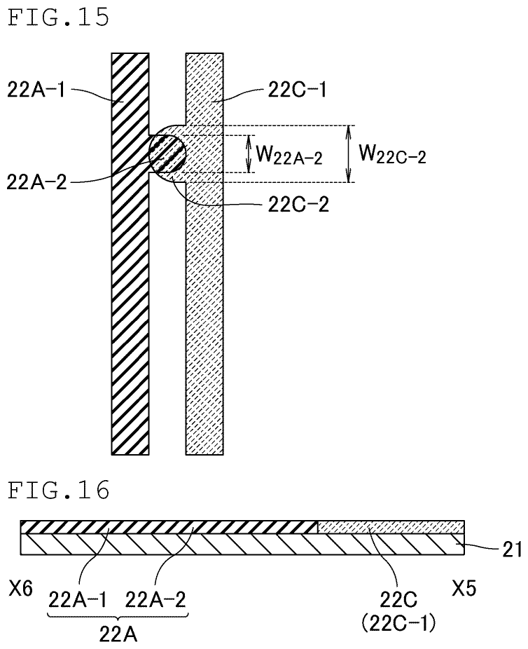

FIG. 16 is a schematic cross-sectional view taken along line X5-X6 in FIG. 13. As shown in FIG. 16, in the case of forming two-layer structure spacers PS2, third-color filters 22C including only the third continuous pattern portions 22C-1 without the third protrusion pattern portion 22C-2 are patterned.

FIG. 17 is a schematic plan view illustrating a third step of the method for producing the color filter substrate in FIG. 3. As shown in FIG. 17, second-color filters 22B including second continuous pattern portions 22B-1 are each formed between a first continuous pattern portion 22A-1 and a third continuous pattern portion 22C-1.

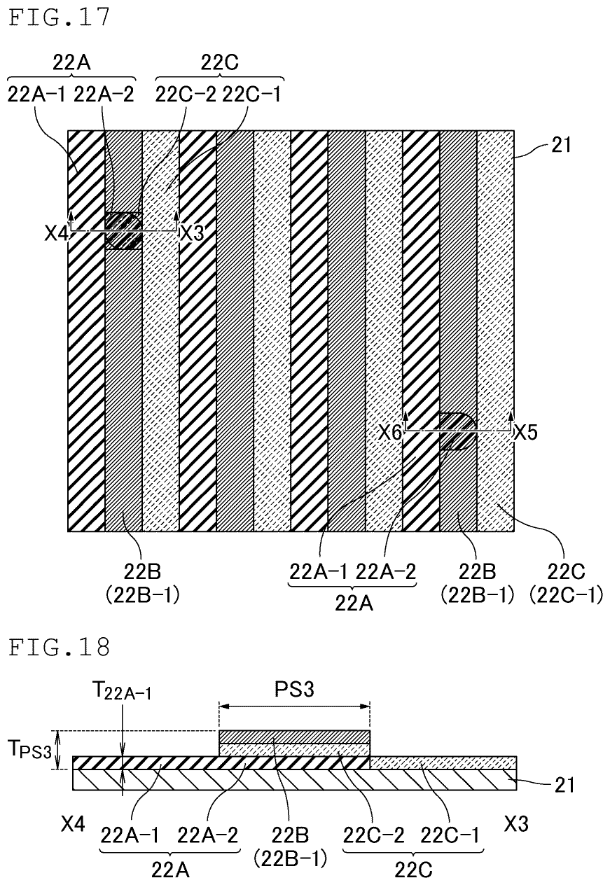

FIG. 18 is a schematic cross-sectional view taken along line X3-X4 in FIG. 17. As shown in FIG. 18, the three-layer structure spacer PS3 is formed including a color filter stack in which, in order from the supporting substrate 21 side, the first protrusion pattern portion 22A-2, the third protrusion pattern portion 22C-2, and the second continuous pattern portion 22B-1 are stacked.

FIG. 19 is a schematic cross-sectional view taken along line X5-X6 in FIG. 17. As shown in FIG. 19, the two-layer structure spacer PS2 is formed including a color filter stack in which, in order from the supporting substrate 21 side, the first protrusion pattern portion 22A-2 and the second continuous pattern portion 22B-1 are stacked.

The stacking order in the color filter layer is not limited to that in the above method. In a three-layer structure spacer PS3, a first protrusion pattern portion 22A-2, a second continuous pattern portion 22B-1, and a third protrusion pattern portion 22C-2 may be stacked in any order. In a two-layer structure spacer PS2, a second continuous pattern portion 22B-1 and a first protrusion pattern portion 22A-2 may be stacked in order from the supporting substrate 21 side. On the other hand, to further increase spacer adhesion, a first-color filter 22A or third-color filter 22C including a continuous pattern portion and a protrusion pattern portion is preferably formed on a supporting substrate (including a black matrix) as a first step. Thus, in the spacer PS3, at least one of the first protrusion pattern portion 22A-2 or the third protrusion pattern portion 22C-2 is preferably disposed closer to the supporting substrate 21 than the second continuous pattern portion 22B-1 is. In the spacer PS2, the first protrusion pattern portion 22A-2 is preferably disposed closer to the supporting substrate 21 than the second continuous pattern portion 22B-1 is.

The methods for patterning the first-color filters 22A, the second-color filters 22B, and the third-color filters 22C may be, for example, photolithography using a material such as a negative or positive photosensitive resin composition containing a colorant such as a pigment or dye of the first color, the second color, and the third color, respectively.

The resin composition applied to form a color filter as the second or third layer may run down a little in a portion constituting the color filter stack, which may make the thicknesses of the color filters as the second and third layers slightly thinner than the thickness of the color filter as the first layer. For this reason, in the case where the spacer is a three-layer structure spacer PS3, as shown in FIG. 18, the thickness T_{PS3} of the color filter stack including the first protrusion pattern portion 22A-2, the part of the second continuous pattern portion 22B-1, and the third protrusion pattern portion 22C-2 may be less than three times the thickness T_{22A-1} of the first continuous pattern portion.

In the case where the spacer is a two-layer structure spacer PS2, as shown in FIG. 19, the thickness T_{PS2} of the color filter stack including the first protrusion pattern portion 22A-2 and the part of the second continuous pattern portion 22B-1 may be smaller than twice the thickness T_{22A-1} of the first continuous pattern portion.

The thicknesses T_{PS2} and T_{PS3} of the spacers PS2 and PS3 can be adjusted by changing the solids concentration and viscosity of the photosensitive resin compositions used for color filters of the respective colors.

Although not shown, alignment films may be disposed, one on the liquid crystal layer 30 side surface of the active matrix substrate 10 and one on the liquid crystal layer 30 side surface of the color filter substrate 20. The alignment films may have been subjected to alignment treatment such as rubbing or photoalignment treatment.

Components such as polarizing plates, a liquid crystal driver, and drive circuits can be mounted on the liquid crystal panel to fabricate a liquid crystal display device. The polarizing plates are attached, for example, one to the surface of the active matrix substrate 10 opposite to the liquid crystal layer 30, and one to the surface of the color filter substrate 20 opposite to the liquid crystal layer 30.

### EXAMPLES

Hereinbelow, the effect of the present invention is described based on examples and comparative examples. The present invention, however, is not limited to these examples.

### Example 1

In Example 1, a liquid crystal panel for HMD was produced which was at about 1200 ppi and driven by active matrix technology. The sizes of a red subpixel, a blue subpixel, and a green subpixel were each 7 μm×21 μm, and the size of a pixel constituted by the three subpixels was 21 μm×21 μm. The display mode of the liquid crystal panel was the FFS mode. The active matrix substrate included TFTs formed using, for example, amorphous silicon, polysilicon, and/or an oxide semiconductor, gate lines, source lines, pixel electrodes disposed in the respective subpixels, and a common electrode disposed on the pixel electrodes with an insulating film in between. The CF substrate included no electrode.

On a transparent substrate to serve as a supporting substrate in the CF substrate, a black matrix having apertures and a light blocking portion was formed. The apertures in the black matrix were formed, as shown in FIG. 1, to be small in subpixels in which the spacers were to be disposed, so that the spacers would be hidden by the light blocking portion.

In Example 1, the first-color filters were red color filters, the second-color filters were blue color filters, and the third-color filters were green color filters. The order of forming the red, blue, and green color filters is not limited. In Example 1, the red (first color) color filters, the green (third color) color filters, and the blue (second color) color filters were formed in the stated order.

In the first step, as shown in FIG. 10 and FIG. 11, the red color filters were formed on the supporting substrate with the black matrix formed. When the extension direction of the gate lines is defined as the row direction and the extension direction of the source lines is defined as the column direction, the red color filters include a color filter having only a continuous pattern portion and a color filter having a continuous pattern portion in the extension direction of the source lines and a protrusion pattern portion protruding from the continuous pattern portion in the row direction. The thicknesses of the continuous pattern portions and the protrusion pattern portions in the red color filters were 1.5 μm. The maximum width of the red protrusion pattern portion in the column direction was about the same as the width of the red continuous pattern portion in the row direction. One red protrusion pattern portion was formed per 8 pixels.

Next, in the second step, as shown in FIG. 13 and FIG. 14, green color filters were formed, with a space corresponding to one column in the row direction of a red color filter. The green color filters, as with the red color filters, included a color filter having a continuous pattern portion and a protrusion pattern portion and a color filter having only a continuous pattern portion, and the thicknesses of the continuous pattern portion and the protrusion pattern portion were each 1.5 μm. The maximum width of the green protrusion pattern portion in the column direction was about the same as the width of the green continuous pattern portion in the row direction. As with the red protrusion pattern portion, one green protrusion pattern portion was formed per 8 pixels.

Subsequently, in the third step, as shown in FIG. 17 and FIG. 18, blue color filters were formed between the red continuous pattern portions and the green continuous pattern portions. In Example 1, since the color filter stacks including a red protrusion pattern portion and a green protrusion pattern portion have already been formed at the positions where the blue color filters were to be formed, the blue color filters had only a continuous pattern portion with no protrusion pattern portion. In this manner, the color filter substrate having one three-layer structure spacer PS3 per 8 pixels was formed. The difference between the thickness T_{PS3} of the spacers PS3 and the thickness of the first continuous pattern portions without the spacer PS3 was 2.5 μm. An overcoat layer may be disposed on the color filter layer as appropriate.

Alignment films were formed, one on a surface of the CF substrate and one on a surface of the active matrix substrate, and then subjected to alignment treatment. Thereafter, the CF substrate and the active matrix substrate were attached with their alignment films facing each other with a nematic liquid crystal material in between. Thereby, a liquid crystal panel was produced. Polarizing plates were then attached, one on a surface of the CF substrate opposite to the liquid crystal layer and one on a surface of the active matrix substrate opposite to the liquid crystal layer, followed by mounting of a liquid crystal driver and drive circuits, so that a liquid crystal display device was obtained.

### Comparative Example 1

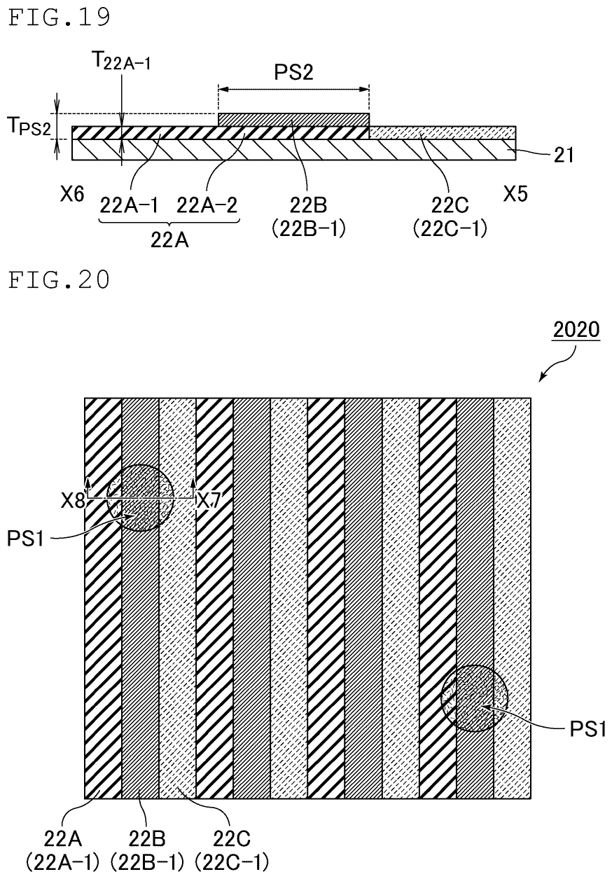

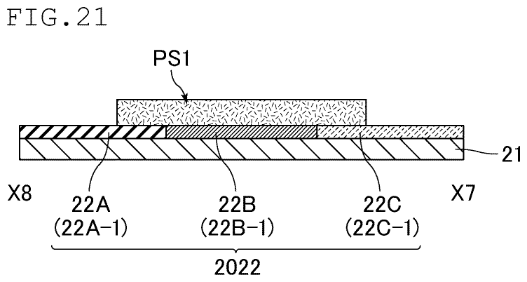

A liquid crystal display device including spacers in a conventional isolated pattern was produced for Comparative Example 1. FIG. 20 is a schematic plan view of a color filter substrate of Comparative Example 1 seen from the liquid crystal layer side. FIG. 21 is a schematic cross-sectional view taken along line X7-X8 in FIG. 20. In Comparative Example 1, a color filter layer 2022 was produced which included red color filters 22A having only first continuous pattern portions 22A-1, blue color filters 22B having only second continuous pattern portions 22B-1, and green color filters 22C having only third continuous pattern portions 22C-1, and then spacers PS1 in an isolated pattern were formed on the color filter layer 2022, so that a color filter substrate 2020 was produced. The spacers PS1 in an isolated pattern were patterned by photolithography using a transparent resin, and the diameter of the spacers PS1 was 14 μm. The density of the spacers PS1 was one per 8 pixels as in Example 1. Thereafter, a liquid crystal display device of Comparative Example 1 was produced using the color filter substrate 2020 as in Example 1.

In the liquid crystal display device of Example 1, the spacers were less likely to peel off and the transmittance was higher by 4% than in the liquid crystal display device of Comparative Example 1. The transmittance during black display was the same in Example 1 and Comparative Example 1. Thus, the liquid crystal display device of Example 1 exhibited a higher display contrast ratio than that of Comparative Example 1 by the amount of the increase in transmittance.

### Example 2

In Example 2, a color filter substrate including one three-layer structure spacer PS3 per 8 pixels was formed as in Example 1, except that in formation of the green color filters in the second step, as shown in FIG. 15, the maximum width of the green protrusion pattern portions in the column direction was greater than the maximum width of the red protrusion pattern portions in the column direction, so that the green protrusion pattern portions covered the red protrusion pattern portions. Thereafter, a liquid crystal display device of Example 2 was produced as in Example 1 using the color filter substrate.

In the liquid crystal display device of Example 2, the spacers were less likely to peel off, the transmittance was higher, and the display contrast ratio was higher than in the liquid crystal display device of Comparative Example 1. In Example 2, the effect of increasing the transmittance and contrast ratio was about half the effect in Example 1 at 1200 ppi. Yet, the spacers can be made even less likely to peel off than in Example 1, and thus the liquid crystal display device of Example 2 can be more suitable for about 1400 ppi (subpixel size 6 μm×18 μm).

### Example 3

In Example 3, a liquid crystal display device was produced which included both three-layer structure spacers PS3 (main spacers) and two-layer structure spacers PS2 (sub spacers). In Example 3, a color filter substrate was formed as in Example 1, except that, in formation of the green color filters in the second step, as shown in FIG. 13 and FIG. 16, some of the green color filters had only a continuous pattern portion with no protrusion pattern portion. Thereafter, a liquid crystal display device of Example 3 was produced as in Example 1 using the color filter substrate.

In the liquid crystal display device of Example 3, as in the liquid crystal display device of Example 1, the spacers were less likely to peel off and the transmittance and display contrast ratio were higher than in Comparative Example 1. In addition, the liquid crystal display device of Example 3 can achieve a favorable balance between the pressure resistance and the effect of preventing low-temperature air bubbles.

### REFERENCE SIGNS LIST

1, 1-A, 1-B, 1-C: subpixel
(1-A)x: first subpixel group
(1-B)x: second subpixel group
(1-C)x: third subpixel group
2: pixel
10: active matrix substrate
11, 21: supporting substrate
12: pixel electrode
20, 2020: color filter substrate
22: color filter layer
22A: first-color filter
22A-1: first continuous pattern portion
22A-2: first protrusion pattern portion
22B: second-color filter
22B-1: second continuous pattern portion
22C: third-color filter
22C-1: third continuous pattern portion
22C-2: third protrusion pattern portion
23: black matrix
23a, 23a-1, 23a-2, 23a-3: aperture
23b: light blocking portion
24: overcoat layer
30: liquid crystal layer
1000: liquid crystal panel
PS1, PS2, PS3: spacer

What is claimed is:

1. A liquid crystal panel including multiple subpixels disposed in a row direction and a column direction, the liquid crystal panel comprising:
an active matrix substrate including pixel electrodes disposed in the respective subpixels;
a color filter substrate; and
a liquid crystal layer sandwiched between the active matrix substrate and the color filter substrate,
the color filter substrate including a color filter layer and multiple spacers protruding toward the liquid crystal layer,
the color filter layer including at least a first-color filter and a second-color filter adjacent to the first-color filter in the row direction,
the first-color filter including a first continuous pattern portion disposed continuously to overlap a first subpixel group arranged in the column direction among the multiple subpixels, and a first protrusion pattern portion protruding in the row direction from the first continuous pattern portion,
the second-color filter including a second continuous pattern portion disposed continuously to overlap a second subpixel group arranged in the column direction among the multiple subpixels,
the multiple spacers each including a color filter stack that includes the first protrusion pattern portion and a part of the second continuous pattern portion.

2. The liquid crystal panel according to claim 1,
wherein the color filter layer further includes a third-color filter adjacent to an opposite side of the second-color filter from the first-color filter in the row direction,
the third-color filter includes a third continuous pattern portion disposed continuously to overlap a third subpixel group arranged in the column direction among the multiple subpixels, and a third protrusion pattern portion protruding in the row direction from the third continuous pattern portion, and
at least one of the spacers among the multiple spacers includes, in its color filter stack, the first protrusion pattern portion, a part of the second continuous pattern portion, and the third protrusion pattern portion.

3. The liquid crystal panel according to claim 2,
wherein a maximum width of the third protrusion pattern portion in the column direction is greater than a maximum width of the first protrusion pattern portion in the column direction.

4. The liquid crystal panel according to claim 1,
wherein the first-color filter is one of a red color filter or a green color filter.

5. The liquid crystal panel according to claim 2,
wherein the first-color filter is one of a red color filter or a green color filter,
the second-color filter is a blue color filter, and the third-color filter is the other of the red color filter or the green color filter.

6. The liquid crystal panel according to claim 1,
wherein the part of the second continuous pattern portion is in a side in the color filter stack closest to the liquid crystal layer.

7. The liquid crystal panel according to claim 1,
wherein the color filter substrate further includes a black matrix,
the black matrix includes multiple apertures arranged in the respective subpixels and a light blocking portion surrounding the multiple apertures,
the multiple spacers include a spacer overlapping the light blocking portion,
the multiple apertures include multiple first apertures overlapping the first continuous pattern portion and multiple second apertures overlapping the second continuous pattern portion except for the part of the second continuous pattern portion, and
the multiple second apertures include a second aperture having a smaller area than the first apertures.

8. The liquid crystal panel according to claim 1,
wherein the color filter substrate includes an overcoat layer disposed in a liquid crystal layer side of the color filter layer, and
a thickness of the overcoat layer is smaller than a thickness of the color filter stack.

9. The liquid crystal panel according to claim 1,
wherein the color filter stack is a stack of the first protrusion pattern portion and the part of the second continuous pattern portion, and
a thickness of the color filter stack is less than twice a thickness of the first continuous pattern portion.

10. The liquid crystal panel according to claim 2,
wherein the color filter stack is a stack of the first protrusion pattern portion, the part of the second continuous pattern portion, and the third protrusion pattern portion, and
a thickness of the color filter stack is less than three times a thickness of the first continuous pattern portion.

11. The liquid crystal panel according to claim 1,
wherein a maximum width of the first protrusion pattern portion in the column direction is equal to or more than 0.5 times and equal to or less than 1.5 times a width of the first continuous pattern portion in the row direction.

12. The liquid crystal panel according to claim 1,
wherein the color filter layer further includes a third-color filter adjacent to an opposite side of the second-color filter from the first-color filter in the row direction,
one subpixel overlapping the first-color filter, one subpixel overlapping the second-color filter, and one subpixel overlapping the third-color filter constitute one pixel,
the liquid crystal panel has a pixel density of 1000 ppi or more, and
the multiple spacers are disposed at a density of one or more per 1000 pixels and one or less per pixel.

13. The liquid crystal panel according to claim 2,
wherein the multiple spacers include main spacers and sub spacers having a smaller thickness than the main spacers,
the color filter stack in each of the main spacers is a stack of the first protrusion pattern portion, the part of the second continuous pattern portion, and the third protrusion pattern portion, and
the color filter stack in each of the sub spacers is a stack of the first protrusion pattern portion or the third protrusion pattern portion and the part of the second continuous pattern portion.

14. The liquid crystal panel according to claim 13,
wherein one subpixel overlapping the first-color filter, one subpixel overlapping the second-color filter, and one subpixel overlapping the third-color filter constitute one pixel, and
the number of the sub spacers per 1000 pixels is equal to or more than the number of the main spacers and equal to or less than 10 times the number of the main spacers.
